(19) United States
(12) Patent Application Publication
(10) Pub. No.: US 2026/0175677 A1
(43) Pub. Date: Jun. 25, 2026

(54) WORKING VEHICLE

(71) Applicant: Kubota Corporation, Osaka (JP)

(72) Inventors: Shunsuke SONODA, Sakai-shi (JP); Hiroyuki NITAMIZU, Sakai-shi (JP); Tomo TANOUE, Sakai-shi (JP)

(21) Appl. No.: 19/421,215

(22) Filed: Dec. 16, 2025

(30) Foreign Application Priority Data
Dec. 24, 2024 (JP) 2024-226874

(51) Int. Cl. B60K 17/24

(52) U.S. Cl. CPC B60K 17/24

(57) ABSTRACT

A work vehicle includes a driving force transmission shaft with an axis oriented in a front-rear direction and to which a driving force of an engine is transmitted, a transmission shaft with an axis oriented in a left-right direction to transmit a driving force from the driving force transmission shaft to left and right front wheels, a front axle case that houses the transmission shaft, and a steering cylinder operable to change a turning angle of the front wheels and provided on the front axle case so as to be positioned above the transmission shaft.

### CROSS REFERENCE TO RELATED APPLICATIONS

This application claims the benefit of priority to Japanese Patent Application No. 2024-226874 filed on Dec. 24, 2024. The entire contents of this application are hereby incorporated herein by reference.

### BACKGROUND OF THE INVENTION

### 1. Field of the Invention

The present disclosure relates to working vehicles.

### 2. Description of the Related Art

Conventionally, a technique of a working vehicle is know. For example, JP 2024-65152 A discloses such a configuration.

JP 2024-65152 A describes a tractor. The tractor includes a front axle mechanism including a front axle case that houses an axle of front wheels, and a steering cylinder coupled to the front axle case. The front axle mechanism changes the turning angle by expanding and contracting the steering cylinder to pivot the front wheels about a fulcrum provided in the front axle case.

Here, in the front axle mechanism as described above, depending on the position of the steering cylinder with respect to the axle, the turning angle of the front wheels with respect to the expansion/contraction amount of the steering cylinder cannot be sufficiently secured, and it may be difficult to suitably change the turning angle of the front wheel.

### SUMMARY OF THE INVENTION

Example embodiments of the present invention provide working vehicles each capable of suitably changing a turning angle of front wheels.

A working vehicle according to an example embodiment of the present disclosure includes a driving force transmission shaft with an axis oriented in a front-rear direction and to which driving force of an engine is transmitted, a transmission shaft with an axis oriented in a left-right direction to transmit driving force from the driving force transmission shaft to left and right front wheels, a front axle case that houses the transmission shaft, and a steering cylinder operable to change a turning angle of the front wheels and provided on the front axle case so as to be positioned above the transmission shaft.

According to an example embodiment of the present disclosure, the turning angle of the front wheels can be suitably changed.

A working vehicle according to an example embodiment of the present disclosure includes a vehicle body frame that supports the front axle case from above and includes a first recess that is recessed upward to allow the steering cylinder to be located inside.

According to an example embodiment of the present disclosure, the height of the hood of the vehicle body can be reduced.

A working vehicle according to an example embodiment of the present disclosure includes a suspension to absorb vibration transmitted from the front axle case to the vehicle body frame, in which the suspension includes a suspension cylinder that connects the vehicle body frame and the front axle case and is positioned in front of the first recess.

According to an example embodiment of the present disclosure, it is possible to reduce or prevent a decrease in rigidity of the vehicle body frame due to the provision of the first recess.

The suspension cylinder according to an example embodiment of the present disclosure is provided at a front end of the vehicle body frame.

According to an example embodiment of the present disclosure, the strength of the portion on the front side of the vehicle body frame can be improved.

A working vehicle according to an example embodiment of the present disclosure includes a vehicle body frame that supports the front axle case from above and includes a second recess on a rear side of the front axle case, the second recess being recessed toward a center side in a left-right direction of the vehicle body frame so as to be able to avoid interference with the front wheels.

According to an example embodiment of the present disclosure, the turning angle of the front wheel can be secured by avoiding interference between the vehicle body frame and the front wheel.

A working vehicle according to an example embodiment of the present disclosure includes a vehicle body frame that supports the front axle case from above and includes a cast portion including a casting and a guide portion capable of guiding a linear body.

According to an example embodiment of the present disclosure, the guide portion capable of guiding the linear body can be include the cast portion which is easily formed into a complicated shape in the vehicle body frame.

The cast portion according to an example embodiment of the present disclosure includes a rib protruding in a predetermined direction, and the guide portion has a groove shape defined by the rib.

According to an example embodiment of the present disclosure, the guide portion can include the rib that reinforces the vehicle body frame.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view illustrating an overall configuration of a tractor according to an example embodiment of the present disclosure.

FIG. 2 is a perspective view illustrating a vehicle body frame, a driving force transmission shaft, a front axle case, a steering cylinder, and a suspension of the tractor.

FIG. 3 is a side view illustrating the vehicle body frame, the driving force transmission shaft, the front axle case, the steering cylinder, and the suspension of the tractor.

FIG. 4 is an exploded perspective view illustrating the vehicle body frame, the driving force transmission shaft, the front axle case, the steering cylinder, and the suspension of the tractor.

FIG. 5 is a perspective view illustrating the vehicle body frame.

FIG. 6 is a plan view illustrating the vehicle body frame.

FIG. 7 is an exploded perspective view illustrating the driving force transmission shaft, the front axle case, and the steering cylinder.

FIG. 8 is a front view schematically illustrating the front axle case and the steering cylinder.

FIG. 9 is a plan view schematically illustrating the front axle case and the steering cylinder.

FIG. 10A is a front view schematically illustrating a conventional front axle case and the steering cylinder.

FIG. 10B is a plan view schematically illustrating a conventional front axle case and the steering cylinder.

### DETAILED DESCRIPTION OF THE EXAMPLE EMBODIMENTS

In the following description, directions indicated by arrows U, D, F, B, L, and R in the drawings are defined as an upward direction, a downward direction, a forward direction, a backward direction, a left direction, and a right direction, respectively.

First, an overall configuration of a tractor 1 according to an example embodiment of the present disclosure will be described.

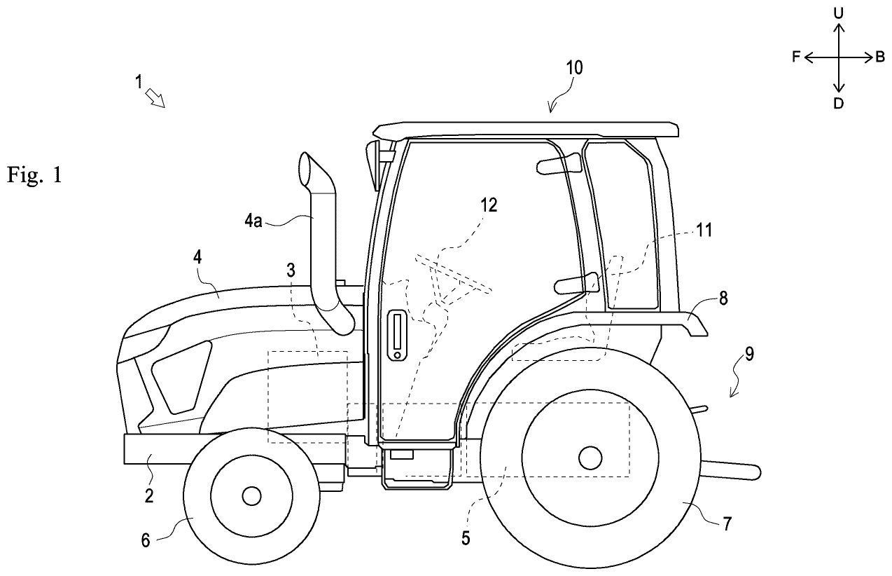

The tractor 1 illustrated in FIG. 1 mainly includes a vehicle body frame 2, an engine 3, a hood 4, a transmission case 5, front wheels 6, rear wheels 7, fenders 8, a lifting device 9, a cabin 10, a driving force transmission shaft 30, a front axle 40, a front axle case 50, a steering cylinder 60, and a suspension 70.

The vehicle body frame 2 is a structure to which the engine 3 and the like are fixed. Note that the configuration of the vehicle body frame 2 will be described in detail later. The vehicle body frame 2 is located at a front portion of the tractor 1. The engine 3 is covered with the hood 4. The transmission case 5 is fixed to a rear portion of the engine 3. A muffler 4a that discharges exhaust gas of the engine 3 is located on the right side of the hood 4.

The transmission case 5 houses a power transmission mechanism (not illustrated). In front of the transmission case 5, a clutch housing that houses a power transmission mechanism (a transmission, a clutch, and the like) (not illustrated) is provided.

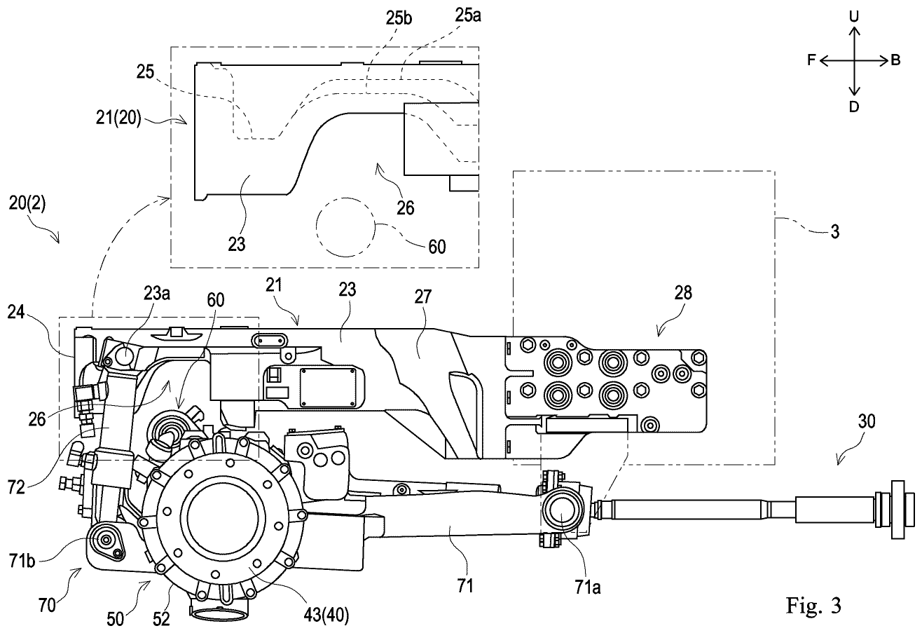

The front portion of the vehicle body frame 2 is supported by the pair of left and right front wheels 6 through a front axle mechanism (front axle case 50 and steering cylinder 60 to be described later). The front axle mechanism is coupled to the vehicle body frame 2 through the suspension 70 to be described later (see FIG. 3). A rear portion of the transmission case 5 is supported by the pair of left and right rear wheels 7 through a rear axle mechanism (not illustrated). The pair of left and right rear wheels 7 are substantially covered from above by the fenders 8.

The lifting device 9 is provided at the rear portion of the transmission case 5. Various work devices (for example, a cultivator or the like) can be attached to the lifting device 9. The lifting device 9 can lift and lower the attached work device by an actuator such as a hydraulic cylinder.

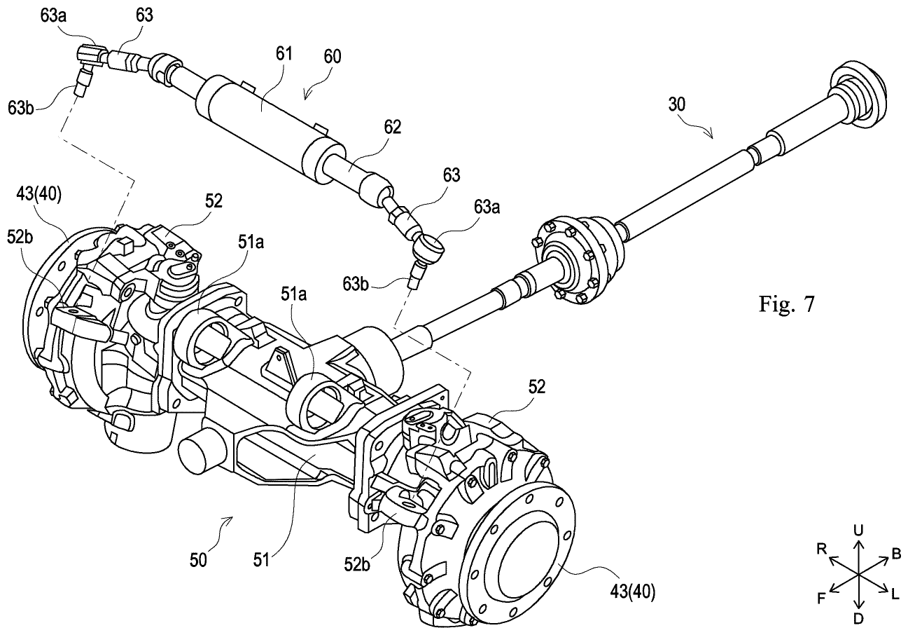

Power of the engine 3 is shifted by the transmission (not illustrated) or the like housed in the clutch housing, and then is transmitted to the front axle mechanism by a driving force transmission shaft 30 (see FIG. 7), and can be transmitted to the front wheels 6 via the front axle mechanism. Further, the power shifted by the transmission is transmitted to the rear wheel 7 via the rear axle mechanism. In this manner, the front wheels 6 and the rear wheels 7 are rotationally driven by the power of the engine 3, and the tractor 1 can travel. In addition, the work device attached to the lifting device 9 can be driven by the power of the engine 3.

The cabin 10 is provided behind the engine 3. The cabin 10 is placed on a vehicle body (such as the transmission case 5). An interior space in which an operator rides is formed inside the cabin 10. In the interior space, a seat 11 on which an operator sits is included. Further, a steering wheel 12 to adjust the turning angle of the front wheels 6 is provided in the front portion of the cabin 10. The steering cylinder 60 described later is operated according to the operation amount of the steering wheel 12, and the turning angle of the front wheels 6 is changed.

Hereinafter, configurations of the vehicle body frame 2, the driving force transmission shaft 30, the front axle 40, the front axle case 50, the steering cylinder 60, and the suspension 70 will be described.

The vehicle body frame 2 illustrated in FIGS. 3, 5, and 6 has a shape elongated in a front-rear direction. In addition to the engine 3 described above, devices (battery, radiator, air cleaner, and the like) located inside the hood 4 are fixed to the vehicle body frame 2. The vehicle body frame 2 according to the present example embodiment includes a cast portion 20 that is a portion formed by casting, and a predetermined sheet metal to fix a predetermined element or structure to the cast portion 20. The cast portion 20 defines a main portion of the vehicle body frame 2. The cast portion 20 is coupled to the front axle mechanism (front axle case 50 and steering cylinder 60) through the suspension 70 to be described later (see FIG. 3). The cast portion 20 includes a first portion 21 and a second portion 28.

The first portion 21 defines a front-side portion of the cast portion 20. On the first portion 21, a device (battery, radiator, air cleaner, and the like) located on the front side in the hood 4 is provided. The first portion 21 has a substantially box shape that opens upward and backward. The rear portion of the first portion 21 is configured so that the vertical dimension gradually increases toward the rear (see FIG. 3). The first portion 21 includes side portions 23 and a front portion 24. The first portion 21 includes a bottom portion 25 having guide portions 25b to be described later. The first portion 21 includes a first recess 26. The first portion 21 includes a second recess 27.

The side portions 23 define left and right side walls of the first portion 21. The side portions 23 are elongated in the front-rear direction. The left and right side portions 23 are symmetrical or substantially symmetrical to each other. The side portions 23 each include a coupling portion 23a.

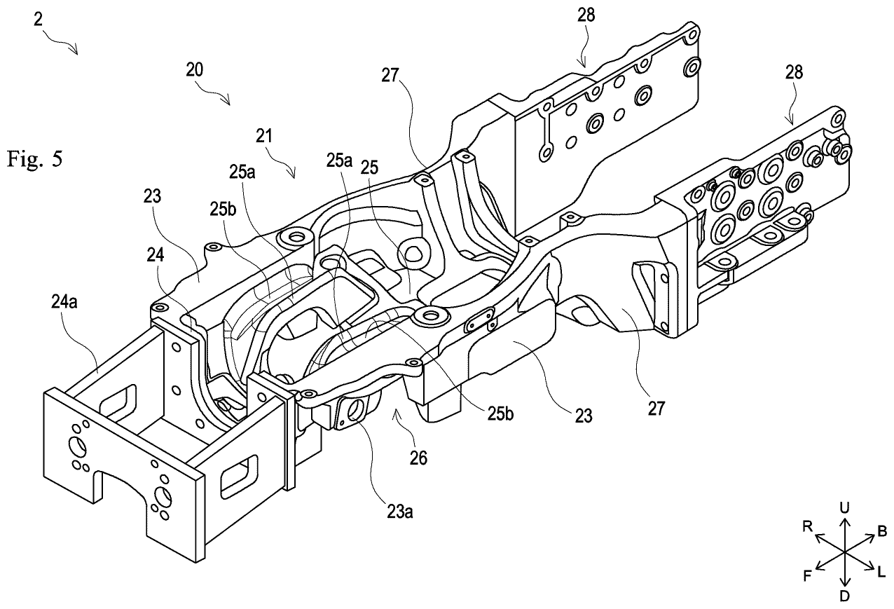

The coupling portion 23a is a portion to which an upper end of a suspension cylinder 72 described later is coupled. The coupling portion 23a is coupled to the suspension cylinder 72 through a predetermined coupling shaft whose axis is oriented in the left-right direction. A hole through which the coupling shaft is inserted is located in the coupling portion 23a. The coupling portion 23a is provided on a surface of the left and right side portions 23 facing outward in the left-right direction. As illustrated in FIGS. 3 and 5, the coupling portion 23a is provided at the front end of the side portion 23.

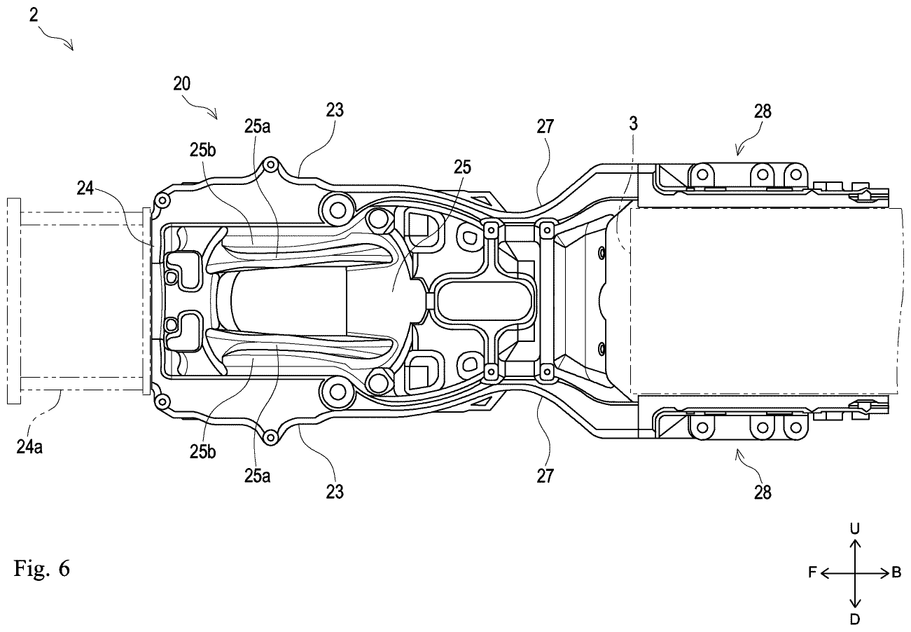

The front portion 24 illustrated in FIGS. 5 and 6 defines a front wall of the first portion 21. The front portion 24 is configured to connect the front ends of the left and right side portions 23 to each other. As illustrated in FIG. 5, the front portion 24 includes a recess in which an upper end is notched downward. The front portion 24 can be provided with a support portion 24a to fix a weight or the like. The support portion 24a includes a combination of sheet metals, for example.

The bottom portion 25 defines a bottom-side wall of the first portion 21. The bottom portion 25 includes ribs 25a and guide portions 25b.

The ribs 25a are portions that protrude upward in the bottom portion 25. The ribs 25a extend in the front-rear direction. The ribs 25a are located at a front-side portion of the bottom portion 25 (first portion 21). The ribs 25a are located on both left and right sides of the front portion 24. The left and right ribs 25a are positioned on a center side in the left-right direction of the bottom portion 25 with a predetermined distance from the left and right side portions 23, respectively. An opening penetrating the bottom portion 25 in the vertical direction is located between the left and right ribs 25a.

The guide portions 25b are portions capable of guiding a predetermined linear body. As the linear body, a hose connected to a predetermined cylinder (for example, steering cylinder 60 or suspension cylinder 72) or an element such as a harness or a wire connected to a predetermined device can be adopted. The guide portions 25b extend in the front-rear direction. The guide portions 25b are located on both left and right sides of the first portion 21. The guide portions 25b according to the present example embodiment each have a groove shape defined by a side portion 23, a rib 25a, and the bottom portion 25.

The first recess 26 illustrated in FIGS. 3 and 5 is a portion recessed upward in the lower portion of the first portion 21. Note that FIG. 3 is an enlarged schematic view of a portion of the first portion 21 where the first recess 26 is located (portion surrounded by one-dot chain line). The first recess 26 is located in the front-side portion of the first portion 21. More specifically, the first recess 26 is located close to the coupling portion 23a of the side portion 23 in the front-rear direction and behind the coupling portion 23a. The first recess 26 has a shape in which the steering cylinder 60 to be described later can be provided inside. More specifically, the longitudinal dimension of the first recess 26 is larger than the longitudinal dimension of a portion (for example, a cylinder tube 61 to be described later) of the steering cylinder 60 overlapping the first portion 21 in a plan view (bottom view). Further, a vertical dimension of the first recess 26 is larger than a vertical dimension of a portion of the steering cylinder 60 overlapping the first portion 21 in plan view.

As illustrated in FIGS. 3 and 5, the ribs 25a and the guide portions 25b according to the present example embodiment straddle the first recess 26 in the front-rear direction. More specifically, the ribs 25a and the guide portions 25b overlap the first recess 26 in plan view. Further, the ribs 25a and the guide portions 25b are curved according to the shape of the first recess 26 in side view (see FIG. 3). With the above configuration, the portion of the cast portion 20 (vehicle body frame 2) where the first recess 26 is located can be reinforced by the rib 25a.

The second recess 27 illustrated in FIGS. 3, 5, and 6 is a portion recessed toward the center side in the left-right direction of the cast portion 20 (vehicle body frame 2). The second recess 27 is located in a rear portion of the side portion 23. The second recess 27 is formed by curving the side portion 23. More specifically, as illustrated in FIG. 6, the left and right side portions 23 are curved such that intermediate portions in the front-rear direction are close to each other, and the second recess 27 is defined by the curved portions.

The second portion 28 defines a rear portion of the cast portion 20. The second portion 28 extends rearward from the left and right side portions 23 of the first portion 21. The left and right second portions 28 are fixed to the rear ends of the left and right side portions 23 using fasteners such as bolts. The left and right second portions 28 sandwich the engine 3 in the left-right direction to fix the engine 3.

The driving force transmission shaft 30 illustrated in FIGS. 3 and 7 transmits power from the engine 3 (transmission device) to the front axle 40 described later. The driving force transmission shaft 30 has a substantially cylindrical shape with its axis oriented substantially in the front-rear direction. A gear (not illustrated) to transmit a driving force (rotation) to the front axle 40, such as a bevel gear, is provided at a front end of the driving force transmission shaft 30.

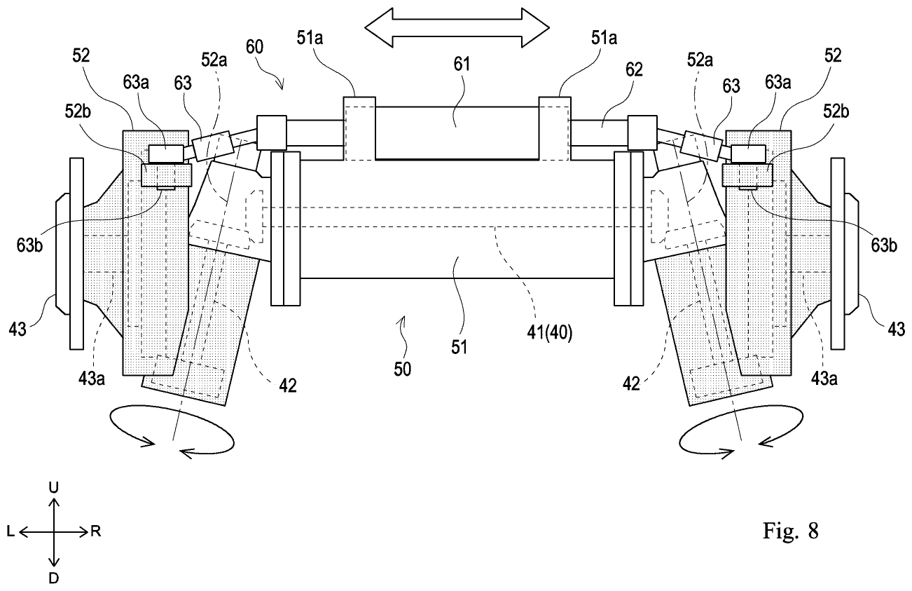

The front axle 40 illustrated in FIG. 8 defines an axle of the left and right front wheels 6. The front axle 40 transmits the rotation transmitted from the driving force transmission shaft 30 to the left and right front wheels 6. The front axle 40 includes a transmission shaft 41, connection shafts 42, and fixing portions 43. Note that various gears to transmit the rotation can be provided in the transmission shaft 41, the connection shafts 42, and the fixing portions 43.

The transmission shaft 41 is a portion to which the driving force from the driving force transmission shaft 30 is transmitted. The transmission shaft 41 is positioned with its axis oriented in the left-right direction.

The connection shafts 42 are portions that transmit the rotation of the transmission shaft 41 to the fixing portions 43 described later. The connection shafts 42 are each positioned with its axis oriented substantially vertically. The connection shafts 42 are provided on the left and right sides of the transmission shaft 41, one on each side.

The fixing portions 43 are portions to which the front wheels 6 are fixed. The fixing portions 43 transmit the rotation of the left and right connection shafts 42 to the left and right front wheels 6, respectively. The fixing portions 43 each have a shaft portion 43a with an axis that is substantially oriented in the left-right direction. The fixing portions 43 each rotate about the shaft portion 43a by the driving force transmitted from the connection shaft 42 through the shaft portion 43a.

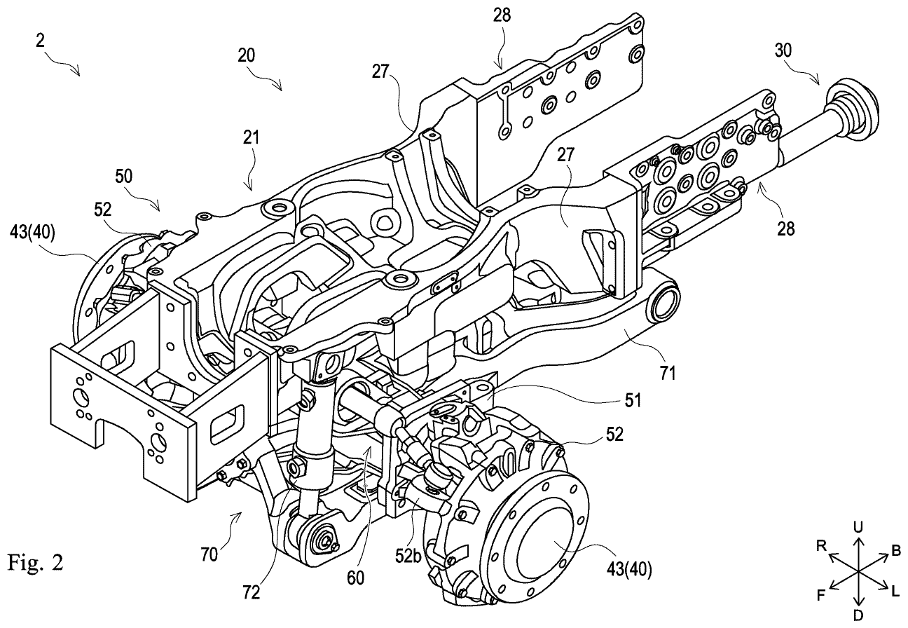

The front axle case 50 illustrated in FIGS. 3, 7, and 8 houses the front axle 40. The front axle case 50 has a hollow shape. The front axle case 50 defines a front axle mechanism together with the steering cylinder 60 to be described later. The front axle case 50 is below the vehicle body frame 2. As illustrated in FIGS. 2 and 3, the front axle case 50 is coupled to the vehicle body frame 2 through the suspension 70 described later. The front axle case 50 is in front of the second recess 27 in the vehicle body frame 2 (first portion 21). The front axle case 50 includes a main body portion 51 and rocker assemblies 52.

The main body portion 51 is a main structural body of the front axle case 50. The main body portion 51 has a substantially cylindrical shape elongated in the left-right direction. As illustrated in FIG. 8, the transmission shaft 41 is housed in the main body portion 51. A rocker 71 of the suspension 70 to be described later is fixed to the lower surface of the main body portion 51. The main body portion 51 includes cylinder holding portions 51a.

The cylinder holding portions 51a illustrated in FIG. 7 support the steering cylinder 60 described later. The cylinder holding portions 51a have a shape opening in the left-right direction, and the steering cylinder 60 is located in an internal space. The cylinder holding portions 51a hold the steering cylinder 60 so as to be positioned in the first recess 26. The cylinder holding portions 51a are provided at an interval in the left-right direction so as to be positioned on both sides in the left-right direction of the main body portion 51. The cylinder holding portions 51a are provided in an obliquely front upper portion of the main body portion 51. More specifically, as illustrated in FIG. 7, the cylinder holding portions 51a are provided on a front side portion of an upper surface of the main body portion 51.

The rocker assemblies 52 each rotatably support the connection shaft 42 and the fixing portion 43 and pivot with respect to the main body portion 51. In FIG. 8, the rocker assemblies 52 are illustrated in a filled manner. As illustrated in FIG. 3, the rocker assemblies 52 have a substantially circular shape in a side view. The rocker assemblies 52 have a hollow shape. Inside each rocker assembly 52, the connection shaft 42 and the shaft portion 43a of the fixing portion 43 are housed. The rocker assemblies 52 are located on the left and right sides of the main body portion 51, one on each side. As illustrated in FIG. 8, each rocker assembly 52 is pivotally coupled to the main body portion 51 about a rocker shaft 52a indicated by one-dot chain line. The rocker shaft 52a is positioned with its axis substantially oriented in the vertical direction. The rocker assemblies 52 pivot with respect to the main body portion 51 by the operation of the steering cylinder 60 described later. The rocker shaft 52a is positioned substantially coaxially with the connection shaft 42. The rocker assemblies 52 each include an arm 52b.

The arm 52b illustrated in FIGS. 7 to 9 is a portion to which a tie rod end 63a of the steering cylinder 60 described later is connected. The arm 52b protrudes obliquely forward and upward from the rocker assembly 52 (see FIGS. 3 and 7).

The steering cylinder 60 illustrated in FIGS. 7 to 9 can change the turning angle of the front wheels 6 according to the operation amount of the steering wheel 12. The steering cylinder 60 defines a power steering mechanism that assists steering using hydraulic pressure. The steering cylinder 60 includes the cylinder tube 61, a cylinder rod 62, and tie rods 63.

The cylinder tube 61 defines a housing of the steering cylinder 60. The cylinder tube 61 has a substantially cylindrical shape elongated in the left-right direction. Oil from an appropriate pump (not illustrated) is supplied into the cylinder tube 61 through a predetermined hose. The cylinder tube 61 is held with respect to the cylinder holding portions 51a by being arranged inside the opening of the cylinder holding portions 51a.

The cylinder rod 62 moves left and right as a piston (not illustrated) is pushed by hydraulic pressure inside the cylinder tube 61. The cylinder rod 62 is elongated in the left-right direction. The cylinder rod 62 projects from both left and right sides of the cylinder tube 61.

The tie rods 63 transmit the motion of the cylinder rod 62 to the rocker assemblies 52. The tie rods 63 are provided on both sides of the cylinder rod 62 in the left-right direction, one on each side. The tie rods 63 connect left and right distal ends of the cylinder rod 62 and the arms 52b of the rocker assemblies 52. The tie rods 63 each include the tie rod end 63a.

The tie rod end 63a is a portion connected to the arm 52b of the rocker assembly 52. The tie rod end 63a is rotatably coupled to the arm 52b about a coupling shaft 63b whose axis is substantially in the vertical direction.

In the power steering mechanism including the steering cylinder 60, by driving a steering valve (not illustrated) according to the operation amount of the steering wheel 12, oil from an appropriate pump (not illustrated) is supplied to the steering cylinder 60, and the cylinder rod 62 moves in the left-right direction by the hydraulic pressure. When the motion of the cylinder rod 62 is transmitted to the rocker assembly 52 through the tie rod 63, the rocker assembly 52 pivots with respect to the main body portion 51, and the turning angle of the front wheels 6 is changed.

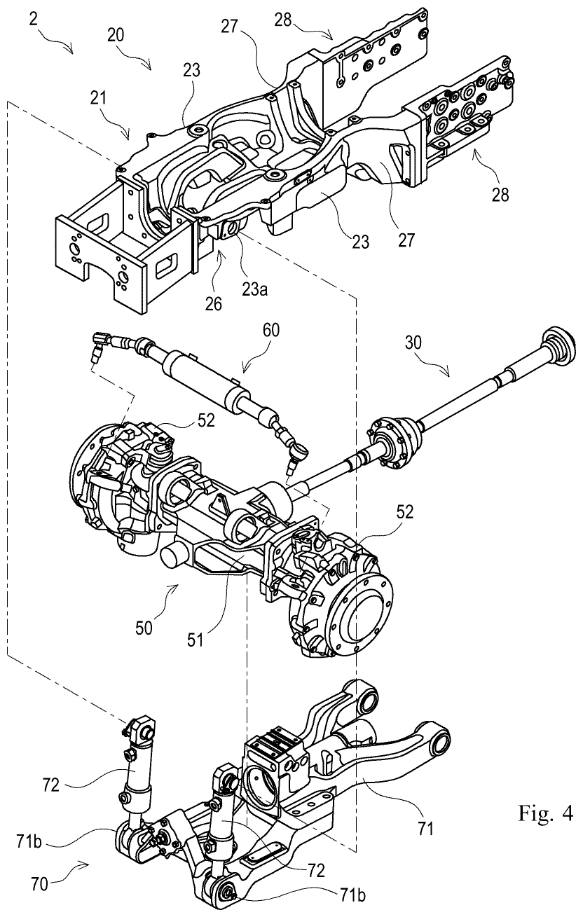

The suspension 70 illustrated in FIGS. 3 and 4 absorbs vibration transmitted from the front axle case 50 (front wheels 6) to the vehicle body frame 2. The suspension 70 couples the front axle case 50 and the vehicle body frame 2. The suspension 70 includes the rocker 71 and the suspension cylinder 72.

The rocker 71 is fixed to the front axle case 50 and pivotally connected to the vehicle body frame 2. The rocker 71 is elongated in the front-rear direction. An upper surface of the front side portion of the rocker 71 is fixed to a lower surface of the front axle case 50 (see FIG. 4). The rocker 71 includes a rocker shaft 71a and a coupling portion 71b.

The rocker shaft 71a illustrated in FIG. 3 is a shaft serving as a rocker center of the rocker 71. The rocker shaft 71a is positioned with its axis oriented in the left-right direction. The rear end of the rocker 71 and the vehicle body frame 2 are coupled through the rocker shaft 71a.

The coupling portion 71b is a portion to which the lower end of the suspension cylinder 72 is coupled. The coupling portion 71b is coupled to the suspension cylinder 72 through a predetermined coupling shaft whose axis is oriented in the left-right direction. A hole through which the coupling shaft is inserted is located in the coupling portion 23a. As illustrated in FIG. 4, the coupling portions 71b are provided on both left and right sides of the front end of the rocker 71, one on each side.

The suspension cylinder 72 absorbs vibration by flow resistance of oil fed by an appropriate pump (not illustrated). The suspension cylinder 72 absorbs vibration by extending and contracting in the vertical direction. A pair of suspension cylinders 72 to connect left and right sides of the vehicle body frame 2 and the rocker 71.

Specifically, as illustrated in FIGS. 3 and 4, the upper end side of the suspension cylinder 72 is rotatably coupled to the coupling portion 23a of the side portion 23 of the vehicle body frame 2 through a coupling shaft. Further, the lower end side of the suspension cylinder 72 is rotatably coupled to the coupling portion 71b of the rocker 71 through a coupling shaft. As illustrated in FIG. 3, the suspension cylinder 72 is positioned in front of the first recess 26. The suspension cylinder 72 is provided at the front end of the side portion 23 of the vehicle body frame 2.

Since the suspension 70 is provided, the suspension cylinder 72 interposed between the front axle case 50 side (rocker 71) and the vehicle body frame 2 can absorb the vibration transmitted from the front axle case 50 (front wheels 6) to the vehicle body frame 2.

The configuration of the tractor 1 according to the present example embodiment has been described above. In the tractor 1 as described above, the turning angle of the front wheels 6 can be suitably changed by relatively increasing the turning angle of the front wheels 6 with respect to the expansion/contraction amount of the steering cylinder 60.

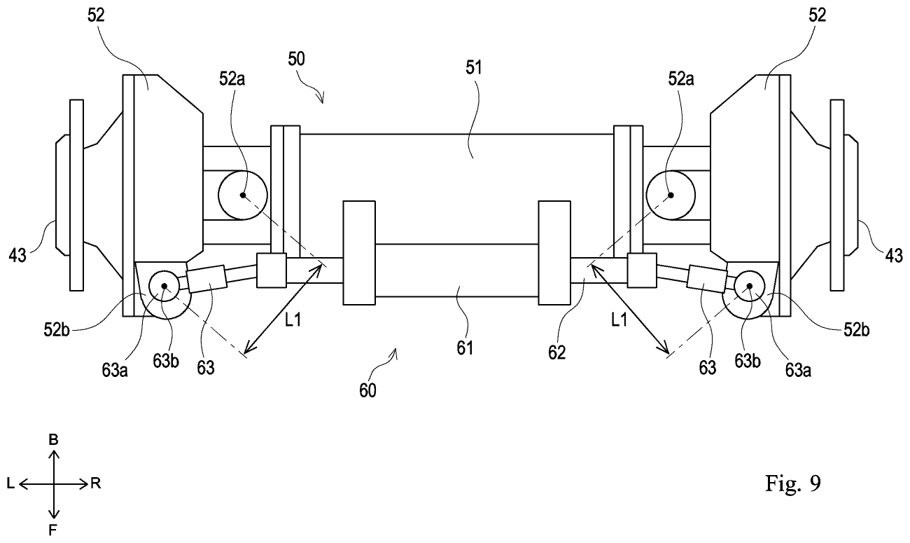

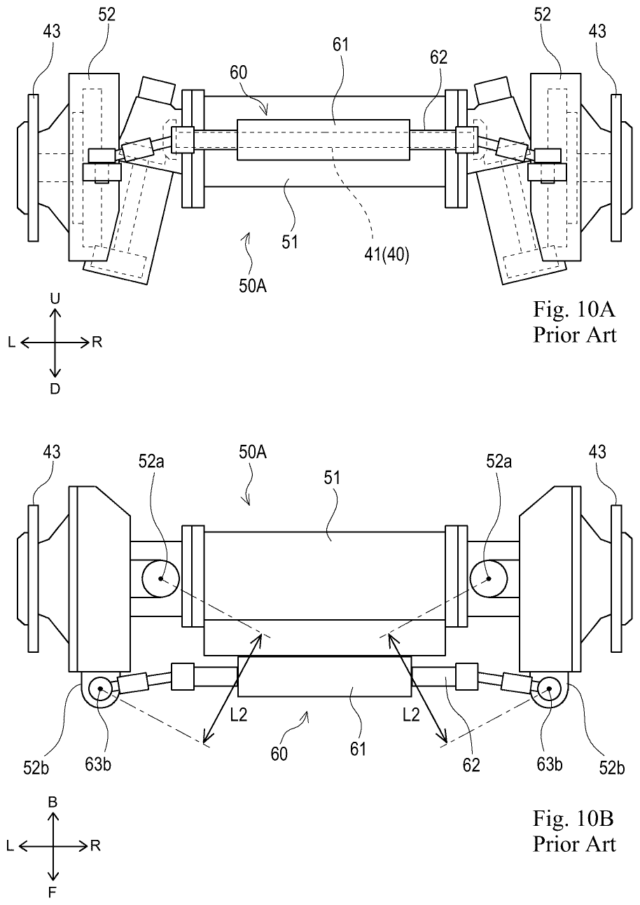

Hereinafter, effects of the tractor 1 according to the present example embodiment will be described using the front axle mechanism (the front axle case 50 and the steering cylinder 60) according to the present example embodiment illustrated in FIGS. 8 and 9 and the front axle mechanism according to the conventional example illustrated in FIGS. 10A and 10B. In the following description of the conventional example, configurations similar to those of the front axle mechanism according to the present example embodiment will be described using the same reference numerals.

As illustrated in FIG. 10A, in the conventional front axle mechanism, the steering cylinder 60 is located at substantially the same height with respect to the transmission shaft 41 of the front axle 40. As illustrated in FIG. 10B, in the conventional example, the steering cylinder 60 is located at the front portion of the front axle case 50A. The arm 52b of the front axle case 50A protrudes forward from the vertically central portion of the rocker assembly 52.

In the conventional example illustrated in FIG. 10B, a distance L2 between the coupling portion (coupling shaft 63b) of the steering cylinder 60 with respect to the rocker assembly 52 of the front axle case 50A and the fulcrum (rocker shaft 52a) of the front wheels 6 is appropriately set so as to be able to avoid interference between the steering cylinder 60 and the front axle case 50.

On the other hand, as illustrated in FIG. 8, in the front axle mechanism according to the present example embodiment, the steering cylinder 60 is located above the transmission shaft 41 of the front axle 40. With the above configuration, as illustrated in FIG. 9, while avoiding interference with the front axle case 50, the distance L1 between the coupling portion of the steering cylinder 60 with respect to the rocker assembly 52 (the coupling shaft 63b of the tie rod end 63a) and the fulcrum (rocker shaft 52a) of the front wheels 6 can be made shorter than L2 illustrated in FIG. 10B. As a result, the turning angle of the front wheels 6 with respect to the expansion/contraction amount of the steering cylinder 60 (the movement amount of the cylinder rod 62 with respect to the cylinder tube 61) can be made relatively large, and the turning angle of the front wheels 6 can be suitably changed.

In general, in a tractor (narrow tractor) having a narrow vehicle width, it is relatively difficult to secure the amount of expansion and contraction of the steering cylinder 60 to secure the turning angle of the front wheels 6. That is, in a narrow tractor assumed to be used in a vineyard, an orchard, or the like, turning performance (a relatively large expansion/contraction amount of the steering cylinder 60) is required. The front axle mechanism according to the present example embodiment can secure a relatively large turning angle of the front wheels 6 with a relatively small expansion/contraction amount of the steering cylinder 60, and thus can be suitably applied to the narrow tractor as described above.

In the tractor 1 according to the present example embodiment, the vehicle body frame 2 (cast portion 20) is provided with the first recess 26 in which the steering cylinder 60 can be located, so that the steering cylinder 60 located above the transmission shaft 41. As a result, the height of the hood 4 of the vehicle body can be reduced while securing the turning angle of the front wheels 6. That is, by providing the first recess 26 in the vehicle body frame 2, for example, even in a case where the suspension cylinder 72 contracts from the state illustrated in FIG. 3, it is possible to avoid interference between the vehicle body frame 2 and the steering cylinder 60. With the above configuration, the vertical distance between the vehicle body frame 2 and the steering cylinder 60 can be made relatively small, and the height of the hood 4 provided above the vehicle body frame 2 can be reduced.

In the present example embodiment, the suspension cylinder 72 connects a portion of the vehicle body frame 2 in front of the first recess 26 and the rocker 71. As a result, it is possible to reduce or prevent a decrease in rigidity of the vehicle body frame 2 (cast portion 20) due to the provision of the first recess 26. Furthermore, in the present example embodiment, the suspension cylinder 72 is connected to the front end (coupling portion 23a) of the vehicle body frame 2. Thus, the strength of the front-side portion (front portion 24) of the vehicle body frame 2 can be improved.

Further, in the present example embodiment, since the steering cylinder 60 is located above the transmission shaft 41, the suspension cylinder 72 can be brought close to the front axle case 50 in the front-rear direction while avoiding interference with the steering cylinder 60 (see FIG. 3). As a result, the vehicle body can be made compact in the front-rear direction.

Further, in the present example embodiment, since the second recess 27 is provided in the vehicle body frame 2 (cast portion 20), it is possible to avoid interference of the front wheel 6 with the vehicle body frame 2. Thus, the turning angle of the front wheels 6 can be secured.

Further, in the present example embodiment, the guide portions 25b are provided in the vehicle body frame 2 (cast portion 20). As a result, it is possible to suitably route a linear body such as a hose to supply oil to the steering cylinder 60 and the suspension cylinder 72 or a structural element such as a harness or a wire connected to a predetermined device using the guide portions 25b. With the above configuration, the number of structural elements can be reduced by using the vehicle body frame 2 (cast portion 20) itself on which the guide portions 25b are structures to guide the linear body. Furthermore, in the present example embodiment, the guide portions 25b can include the ribs 25a that reinforce the first recess 26 of the vehicle body frame 2.

In the present example embodiment, since most of the vehicle body frame 2 is defined by the cast portion 20, the vehicle body frame 2 having a complicated shape including the ribs 25a, the guide portions 25b, the first recess 26, the second recess 27, and the like can be easily formed.

As described above, the tractor 1 (working vehicle) according to the present example embodiment includes the driving force transmission shaft 30 with an axis oriented in a front-rear direction and to which driving force of the engine 3 is transmitted, the transmission shaft 41 with an axis oriented in a left-right direction to transmit a driving force from the driving force transmission shaft 30 to the left and right front wheels 6, the front axle case 50 that houses the transmission shaft 41, and the steering cylinder 60 operable to change a turning angle of the front wheels 6 and provided on the front axle case 50 so as to be positioned above the transmission shaft 41.

With such a configuration, the turning angle of the front wheels 6 can be suitably changed. That is, since the steering cylinder 60 is located above the transmission shaft 41, it is possible to relatively shorten the distance L1 between the coupling portion (coupling shaft 63b) of the steering cylinder 60 with respect to the front axle case 50 and the fulcrum (rocker shaft 52a) of the front wheels 6 while avoiding interference with the front axle case 50. As a result, the turning angle of the front wheels 6 with respect to the expansion/contraction amount of the steering cylinder 60 can be made relatively large.

Further, the tractor 1 includes the vehicle body frame 2 that supports the front axle case 50 from above and includes the first recess 26 that is recessed upward to allow the steering cylinder 60 to be located inside.

With such a configuration, the height of the hood 4 of the vehicle body can be reduced. That is, by providing the first recess 26, it is possible to avoid interference between the vehicle body frame 2 and the steering cylinder 60. As a result, the vertical distance between the vehicle body frame 2 and the steering cylinder 60 can be made relatively small, and the height of the hood 4 provided on the vehicle body frame 2 can be reduced.

Further, the tractor 1 also includes the suspension 70 to absorb vibration transmitted from the front axle case 50 to the vehicle body frame 2 and including the suspension cylinder 72 that connects the vehicle body frame 2 and the front axle case 50 and is positioned in front of the first recess 26.

With such a configuration, it is possible to reduce or prevent a decrease in rigidity of the vehicle body frame 2 due to the provision of the first recess 26.

Further, the suspension cylinder 72 is provided at a front end of the vehicle body frame 2.

With this configuration, the strength of the front-side portion (front portion 24) of the vehicle body frame 2 can be improved.

Further, the tractor 1 also includes the vehicle body frame 2 that supports the front axle case 50 from above and includes the second recess 27 that is located in a portion of the vehicle body frame 2 on the rear side of the front axle case 50 and recessed toward the center side in the left-right direction of the vehicle body frame 2 so as to avoid interference with the front wheels 6.

With such a configuration, it is possible to secure the turning angle of the front wheels 6 by avoiding interference between the vehicle body frame 2 and the front wheels 6.

Further, the tractor 1 also includes a vehicle body frame 2 that supports the front axle case from above and includes a cast portion 20 including a casting and a guide portion 25b to guide a linear body.

With such a configuration, the guide portion 25b to guide the linear body can include the cast portion 20 which is easily formed into a complicated shape in the vehicle body frame 2.

Further, the cast portion 20 includes a rib 25a protruding in a predetermined direction and the guide portion 25b has a groove shape defined by the rib 25a.

With such a configuration, the guide portions 25b can include the rib 25a to reinforce the vehicle body frame 2.

Note that the tractors 1 according to the present example embodiments are example embodiments of the working vehicles according to the present disclosure.

Although example embodiments of the present disclosure have been described above, the present disclosure is not limited to the above configurations, and various modifications can be made within the scope of the present disclosure.

For example, the shape and the like of each structural element (the vehicle body frame 2, the driving force transmission shaft 30, the front axle 40, the front axle case 50, the steering cylinder 60, the suspension 70, and the like) described in the above example embodiments are merely examples, and are not limited to the above-described shape and the like. The shape and the like of each structural element can be changed to any shape. In addition, the arrangement of each of the above-described structural elements can be appropriately changed.

Further, in the above example embodiments, the examples in which the guide portions 25b (the ribs 25a), the first recess 26, and the second recess 27 are provided in the cast portion 20 has been described, but the present disclosure is not limited to such configurations. For example, a configuration in which some or all of the guide portions 25b, the first recess 26, and the second recess 27 are not included can also be adopted.

Further, in the above example embodiments, examples have been described in which most of the vehicle body frame 2 is defined by the cast portion 20, but the present disclosure is not limited to such configurations. For example, a portion (for example, the second portion 28) or the whole of the cast portion 20 illustrated in the present example embodiment may be defined by a sheet metal or the like.

Further, in the above example embodiments, the tractors 1 have been exemplified as the working vehicles, but the working vehicles are not limited to such an aspect. For example, the working vehicles may be other agricultural vehicles, construction vehicles, industrial vehicles, or the like.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working vehicle comprising:
a driving force transmission shaft with an axis oriented in a front-rear direction and to which a driving force of an engine is transmitted;
a transmission shaft with an axis oriented in a left-right direction to transmit driving force from the driving force transmission shaft to left and right front wheels;
a front axle case that houses the transmission shaft; and
a steering cylinder operable to change a turning angle of the front wheels and provided on the front axle case so as to be positioned above the transmission shaft.

2. The working vehicle according to claim 1, further comprising:
a vehicle body frame that supports the front axle case from above; wherein
the vehicle body frame includes a first recess that is recessed upward to allow the steering cylinder to be located inside.

3. The working vehicle according to claim 2, further comprising:
a suspension to absorb vibration transmitted from the front axle case to the vehicle body frame; wherein
the suspension includes a suspension cylinder that connects the vehicle body frame and the front axle case and is positioned in front of the first recess.

4. The working vehicle according to claim 3, wherein the suspension cylinder is provided at a front end of the vehicle body frame.

5. The working vehicle according to claim 1, further comprising:
a vehicle body frame that supports the front axle case from above; wherein
a second recess is located in a portion of the vehicle body frame on a rear side of the front axle case, the second recess being recessed toward a center side in a left-right direction of the vehicle body frame so as to be able to avoid interference with the front wheels.

6. The working vehicle according to claim 1, further comprising:
a vehicle body frame that supports the front axle case from above; wherein
the vehicle body frame includes a cast portion including a casting; and
the cast portion includes a guide portion to guide a linear body.

7. The working vehicle according to claim 6, wherein
the cast portion includes a rib protruding in a predetermined direction; and
the guide portion has a groove shape defined by the rib.
